(19) United States
(12) Patent Application Publication
(10) Pub. No.: US 2010/0100401 A1
(43) Pub. Date: Apr. 22, 2010

(54) System And Method For Sizing Enterprise Application Systems

(76) Inventors: Jerome Rolia, Kanata (CA); Ludmila Cherkasova, Sunnyvale, CA (US); Sven Graupner, Mountain View, CA (US); Michael Pogrebisky, Rishon Le-Zion (IL)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/252,395

(22) Filed: Oct. 16, 2008

(51) Int. Cl. G06Q 10/00

(52) U.S. Cl. 705/7

(57) ABSTRACT

Embodiments of the present invention recite a system and computer-implemented method for sizing enterprise-application systems. In one embodiment of the present invention, a ratio of a plurality of pre-defined benchmarks is determined. The workload of the ratio-of pre-defined benchmarks corresponds to a desired workload of an enterprise application system. The ratio of the plurality of pre-defined benchmarks is then used as a second benchmark for testing the enterprise application system.

### FIELD OF THE INVENTION

Embodiments of the present invention are related to the field of enterprise application system systems.

### BACKGROUND OF THE INVENTION

With the increasing use and integration of Internet based commerce systems, it is becoming important to create systems which can accurately model the workload imposed upon enterprise application systems. One modeling method utilizes benchmarks to impose a synthetic workload on the enterprise application system being tested. The use of benchmarks facilitates the management of the enterprise application system in areas such as capacity planning and service level performance.

As an example, an enterprise can identify which business processes are to be utilized in support of its e-commerce model. A typical business process (e.g., ordering) may in turn invoke a number of discreet business objects in order to complete the process. Furthermore, a given business object may be characterized by a particular sequence of interdependent requests which are exchanged between entities in the enterprise application system. In other words, the sequence of interdependent requests should be performed correctly in order to correctly implement the business process. Thus, a benchmark for modeling the enterprise application system should accurately reflect the correct sequence and volume of interdependent requests. Otherwise, an incorrect sequence of interdependent requests may cause an error condition that does not accurately model the demands placed upon the enterprise application system.

However, conventional stress testing of enterprise application systems is based upon a small number of pre-existing benchmarks which typically utilize a small subset of business objects. As a result, it is difficult to generate a synthetic workload which accurately models the actual request patterns expected at the enterprise application system. Alternatively, creating a customized benchmark which is representative of a given enterprise is typically too time consuming and expensive for many users.

### SUMMARY OF THE INVENTION

Embodiments of the present invention recite a system and computer-implemented method for sizing enterprise application systems. In one embodiment of the present invention, a ratio of a plurality of pre-defined benchmarks is determined. The workload of the ratio of pre-defined benchmarks corresponds to a desired workload of an enterprise application system. The ratio of the plurality of pre-defined benchmarks is then used as a second benchmark for testing the enterprise application system.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 is a flowchart of a method for sizing an enterprise application system in accordance with one embodiment of the present invention.

FIG. 2 is a block diagram of an exemplary enterprise application system in accordance with an embodiment of the present invention.

FIG. 3 is a block diagram showing the selection of business processes and business objects in accordance with an embodiment of the present invention.

FIG. 4A shows a plurality of benchmarks which are expressed as vectors of business objects in accordance with an embodiment of the present invention.

FIG. 4B shows a plurality of benchmarks which are expressed as vectors of business objects, and respective scalar values in accordance with embodiments of the present invention.

FIG. 5 is a flowchart of a method for sizing an enterprise application system in accordance with one embodiment of the present invention.

FIG. 6 is a block diagram of a computer system upon which embodiments of the present invention may be implemented in accordance with embodiments of the present invention.

FIG. 7 is a block diagram of an enterprise application sizing apparatus in accordance with an embodiment of the present invention.

### DETAILED DESCRIPTION OF THE PREFERRED EMBODIMENT

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signal capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as □generating, □summing, □□□determining, □□deriving, □□accessing, □□selecting, □□assigning, □or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

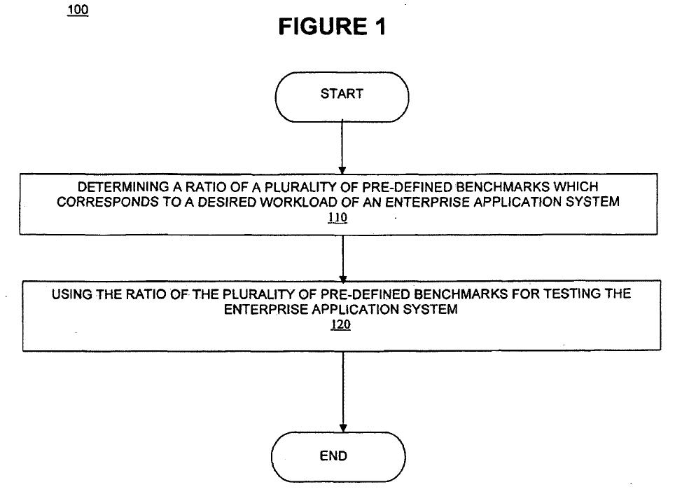

FIG. 1 is a flowchart of a computer-implemented method 100 for sizing an enterprise application system in accordance with embodiments of the present invention. In operation 110 of FIG. 1, a ratio is determined of a plurality of pre-defined benchmarks corresponds to a desired workload of an enterprise application system. In one embodiment the sizing of an enterprise application system is performed to determine the infrastructure and configuration needs of a user of an enterprise application system. As will be described in greater detail below, embodiments of the present invention comprise a computer implemented method determine a ratio of pre-defined benchmarks which corresponds to a desired workload of an enterprise application system.

In operation 120 of FIG. 1, the ratio of the plurality of pre-defined benchmarks is used as a second benchmark for testing the enterprise application system. In embodiments of the present invention, the ratio of pre-defined benchmarks is saved and is used as a customized benchmark for testing and modeling of the desired workload for a client. As will be described in greater detail below, embodiments of the present invention are advantageous in creating a customized benchmark for an enterprise application system more rapidly than conventional methods for creating a customized benchmark for an enterprise application system.

Enterprise application systems refers to integrated software and computer systems which are increasingly used to support business functions which include, but are not limited to, accounting, ordering, customer relations, production and supply chain management, resource planning, billing systems, financial maintenance, etc. Frequently, third party service providers host these services for business entities via the Internet. These service providers may utilize a network of servers for data storage, messaging, database management, web servers, application servers, security, and data archival.

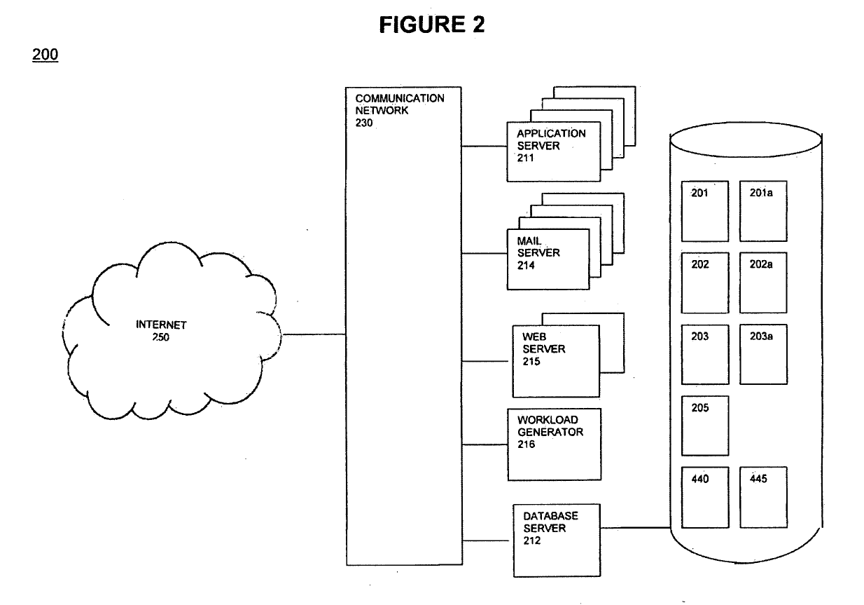

FIG. 2 is a block diagram of an enterprise application system in accordance with an embodiment of the present invention. In FIG. 2, a data center 210 is coupled with the Internet 250 via a communication network 230. In embodiments of the present invention, communication network 230 comprises a wired and/or wireless network which supports data center 200. Communication network 230 provides network security, load balancing, network connectivity and the like for data center 210. In FIG. 2, data center 210 comprises application server(s) 211 and a database server 212 which is communicatively coupled with database 213. Database 213 may be implemented upon a network of data storage device in one embodiment of the present invention. Enterprise application system 200 further comprises mail server(s) 214 and web server(s) 215 which are also communicatively coupled with communication network 230. In the embodiment of FIG. 2, enterprise application system 200 further comprises a workload generator 216. It is noted that in embodiments of the present invention, enterprise application system 200 may alternatively be implemented upon a single computer system, or may be implemented as a networked system of devices.

As shown in FIG. 2, a plurality of benchmarks (e.g., 201, 202, and 203) is stored in database 213 which are described in greater detail below. Also described in greater detail below are a plurality of performance metrics 201a, 202a, and 203a which are associated with benchmarks 201, 202, and 203 respectively. In the embodiment of FIG. 2, a customized customer business process 205, a second benchmark 440 and a performance model 445 are also stored in database 213.

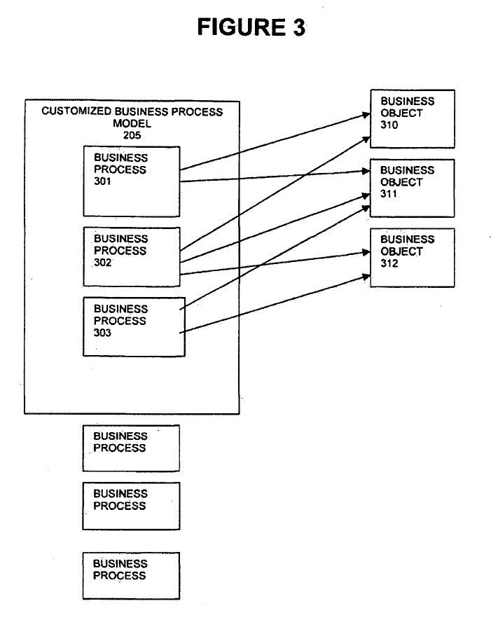

Referring now to FIG. 3, a client typically selects from a generalized process model which describes business processes and business process variants that are available via the enterprise application system (e.g., provided by the third party service provider). Thus, the client specifies which business processes (e.g., business processes 301, 302, 303 of FIG. 3) are to be used and in what proportion. This unique mix of business processes, and variants thereof, describes a customized business process model 205 for the client. The client may additionally provide non-functional parameters for the processes such as the expected number of users, expected think times, throughputs, response time requirements, etc. The client may further customize existing business process steps which may cause messaging exchanges with other systems. The end result is a customized business process model 205 for the client. The customized business process model 205 also defines a desired workload for the enterprise application system for that particular client.

A typical business process interacts with business objects (e.g., business objects 310, 311, and 312 of FIG. 3) in various combinations. Each business object causes certain demands upon the execution services based on its internal application logic. The execution services in turn cause demands on the distributed resources with capacity attributes such as CPU usage, memory usage, storage and network resources, etc.

Based upon the client□s desired workload, resources of enterprise application system 200 are allocated in order to provide the desired level of service to the client. In order to correctly allocate those resources, many enterprise application systems utilize benchmarks to anticipate how the client□s desired workload will impact the infrastructure of data center 210. Unfortunately, the allocation of resources is often based upon a small number of benchmarks which rely upon a small subset of objects. Typically, these benchmarks do not accurately represent unique workload which the customized business process model 205 defines. For example, business objects (e.g., 310, 311, and 312 of FIG. 3) rely upon sequences of interdependent requests which are submitted to the system. Dependencies between the requests are because some requests in a session depend upon responses from earlier requests in a session. Using objects in incorrect sequences can cause error conditions that would lead to atypical resource demands. Thus, if the benchmark does, not accurately reflect the sequences and dependencies which result from the customized business process model 205 created by the client, an incorrect allocation of resources may occur.

As described above, conventional stress testing of enterprise application systems is based upon a small number of pre-existing benchmarks which typically utilize a small subset of business objects. As a result, it is difficult to generate a synthetic workload which accurately models the actual request patterns expected at the enterprise application system. Additionally, the existing benchmarks are unlikely to accurately model the specific sequences and dependencies which result from the customized business process model 205 created by the client. As a result, conventional stress testing, which relies upon benchmarks, is not likely to represent the workload imposed upon the enterprise application system due to the client□s customized business process model 205. Alternatively, creating a customized benchmark which is representative of a given enterprise is typically too time consuming and expensive for many users. This is especially the case with third party service providers who may be hosting hundreds, or thousands, of clients.

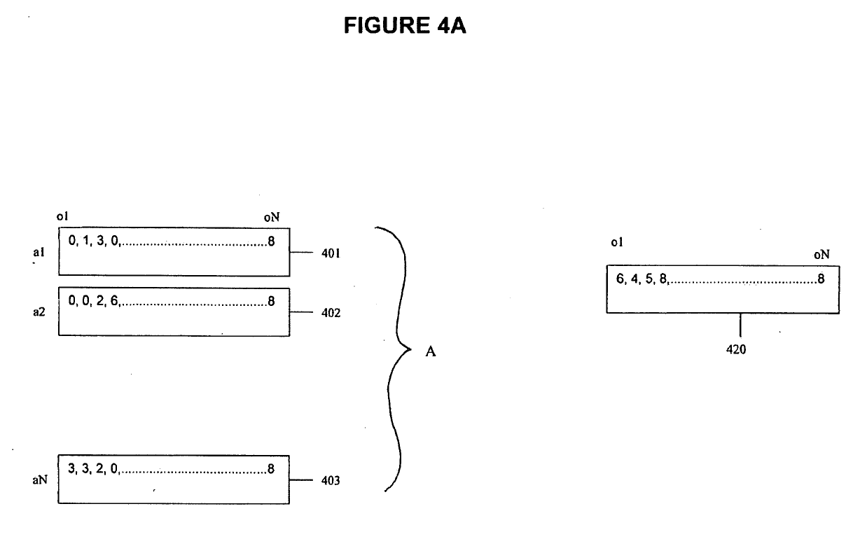

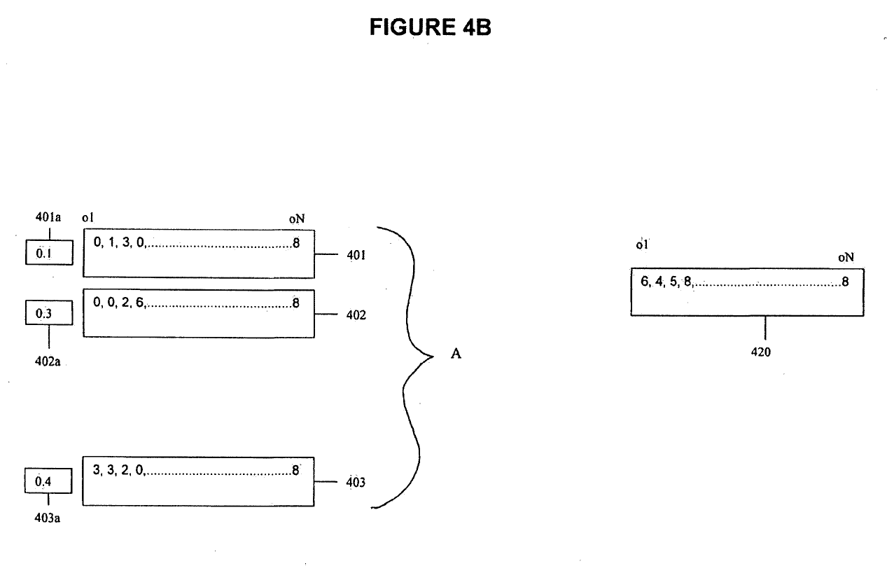

In one embodiment, the customized business process model 205 created by a client is represented as a vector which describes the ratio of business objects which are invoked in a given period. With reference now to FIG. 4A, the vector describing the ratio of business objects invoked in the client□s customized business process model 205 is shown as vector 420. In vector 420 business objects o1-oM are represented as values within vector 420 which describe the number of times each business object is invoked. In other words, vector 420 defines a ratio of business objects invoked by the customized business process model 205 created by the client. It is noted that while vector 420 is based upon the projected workload imposed due to the customized business process model 205 created by a client, embodiments of the present invention may also utilize the client□s historical data to derive vector 420 in embodiments of the present invention. In the example of FIG. 4A, vector 420 shows that business object 1 is invoked six time, business object 2 is invoked four times, business object 3 is invoked five times, business object 4 is invoked eight time, and business object M is invoked eight times in a given time period. As stated above, these values result from the customization of the business process model 205 created by the client. Because of the number of variables which contribute to the ratio described by vector 420, it is unlikely that a pre-defined benchmark used by enterprise application system 200 corresponds with that particular ratio.

Also shown in FIG. 4A are vectors 401, 402, and 403 which describe a ratio of business objects respectively invoked by a set of pre-defined benchmarks (e.g., benchmarks 201, 202, and 203 respectively of FIG. 2). It is noted that set A can comprise a number between 1 and N in embodiments of the present invention. In FIG. 4A, each of vectors 401, 402, and 403 are defined as a vector in which business objects o1-oM are represented as values within a respective vector. Thus, in vector 401, business object 1, which corresponds to business object 1 of vector 420, is invoked zero times, business object 2 is invoked one time, business object 3 is invoked three times, and business object M is invoked 0.3 times when benchmark 201 is executed. Benchmarks 202 and 203 are defined by different ratios of the business objects shown in vectors 402 and 403 respectively. It is noted that there may not be a one-to-one correspondence between business objects invoked in vectors 401, 402, 403, and the business objects invoked by vector 420 in embodiments of the present invention.

In embodiments of the present invention, the benchmarks represented by the vectors comprising set A are selected from a larger set of pre-defined benchmarks which are utilized by enterprise application system 200. In embodiments of the present invention, each of the benchmarks (e.g., 201, 202, and 203) used by enterprise application system 200, including the benchmarks represented in set A, have been previously executed in a controlled environment to generate a set of performance metrics which describe the resource demands placed upon enterprise application system 200 as well as throughputs that can be supported while satisfying certain non-functional requirements. Thus, each pre-defined benchmark represented in set A is uniquely associated with a corresponding set of performance metrics (e.g., 201a, 202a, and 203a of FIG. 2) which describe resource demands placed upon enterprise application system 200 when a given benchmark is executed. Each benchmark can be executed for different usage scenarios which account for variables including, but not limited to:
Different numbers of users;
Branching probabilities or loop counts within a business process;
Process variant mixes;
Database sizes, distributions of data, and distribution of the use of data;
Resource types and other non-functional properties.

In embodiments of the present invention, the pre-defined benchmarks represented by set A are selected to utilize the M business objects of vector 420. In one embodiment, the pre-defined benchmarks represented by set A are selected to utilize all of the M business objects of vector 420. In another embodiment, the pre-defined benchmarks represented by set A are selected to utilize only some of the M business objects of vector 420 such as those identified to affect the performance of enterprise application system 200 the most. Additionally, the benchmarks are selected so that the vectors comprising set A are selected to be linearly independent, or nearly linearly independent, from other vectors in set A. As shown in FIG. 4A, vectors 401, 402, and 403 utilize the business objects o1-oM in different ratios. Additionally, each of vectors 401, 402, and 403 utilize the business objects o1-oM in different ratios than that of vector 420. This reflects the difficulty in finding a pre-defined benchmark which accurately models the resource demands placed upon enterprise application system 200 by a customized business process model 205 created by a client.

In embodiments of the present invention, an iterative process is performed to solve for the problem Ax+B where A comprises set A of vectors a1-aN, and B comprises vector 420. As shown in FIG. 4B, each of vectors 401, 402, and 403 is assigned a respective scalar value (e.g., 401a, 402a, and 403a respectively). In embodiments of the present invention, the scalar values assigned to respective vectors 401, 402, and 403 are selected such that the sum of the products of the scalar values and their respective vectors is within a threshold value of vector 420. For example, scalar value 401 a is multiplied by vector 401 which results in a new value of the business objects invoked. Similarly, scalar values 402a and 403a are multiplied by vectors 402 and 403 respectively which results in new values of the business objects invoked. It is noted that the ratios of business objects invoked by benchmarks 401, 402 and 403 remain the same. In embodiments of the present invention, the sum of the new values of business objects invoked by the benchmarks represented by vectors 401, 402 and 403 equals the sum of the business objects represented in vector 420. In another embodiment, the scalar values are selected such that the difference between the sum of values of business objects invoked by the benchmarks represented by vectors 401, 402 and 403 and the sum of the business objects represented in vector 420 is minimized. In one embodiment, if the difference between the sum of values of business objects invoked by the benchmarks represented by vectors 401, 402 and 403 and the sum of the business objects represented in vector 420 is not within a threshold value, the iterative process is terminated. An example of the process for determining vectors 401, 402, 403, and 420 is described in an article titled □A Synthetic Workload Generation technique for Stress Testing Session-Based Systems, □by Diwakar Krishnamurthy, Jerome A. Rolia, and Shikharesh Majumdar, in the November 2006 edition of IEEE Transactions on Software Engineering, volume 32, number 11, pages 868-882.

In the example of FIG. 4B, vector 401 is multiplied by 0.1, vector 402 is multiplied by 0.3, and vector 403 is multiplied by 0.4. In embodiments of the present invention, the ratios of vectors 401, 402, and 403 are applied to the corresponding benchmarks (e.g., benchmarks 201, 202, and 203 respectively of FIG. 2) which they represent to create a second benchmark 440. In other words, the workload created when second benchmark 440 is executed comprises the sum of ten percent of the workload created when benchmark 201 is executed, thirty percent of the workload created when benchmark 202 is executed, and forty percent of the workload created when benchmark 203 is executed in addition to any other benchmarks not represented in FIGS. 4A and 4B. Thus, by creating a second vector comprising a ratio of benchmarks 201, 202, and 203 which corresponds to the workload represented by vector 420, embodiments of the present invention are able to create a second benchmark comprising a ratio of pre-defined benchmarks which correspond to the desired workload imposed on enterprise application system 200 by the customized business process model 205 created by the client.

Embodiments of the present invention are advantageous in that second benchmark 440 more closely models the workload imposed by the client□s customized business process model 205 than any of the pre-defined benchmarks (e.g., 201, 202, and 203 of FIG. 2) previously used by enterprise application system 200. Additionally, second benchmark 440 can be created at a lower cost and in less time than conventional methods for creating a customized benchmark for a client. Additionally, in environments when a large number of customized benchmarks may be desired, such as for a third party service providers, embodiments of the present invention facilitate resource allocation and stress testing of deployed systems more economically than conventional methods.

As described above, each of the benchmarks (e.g., benchmarks 201, 202, and 203 of FIG. 2) comprising second benchmark 440 can be previously executed in a controlled environment to generate a set of performance metrics (e.g., 201a, 202a, and 203a of FIG. 2) which describe the resource demands placed upon enterprise application system 200 as well as throughputs that can be supported while satisfying certain non-functional requirements. Thus, the performance metrics associated with second benchmark 440 comprises performance metrics 201a, 202a, and 203a in the ratio defined by respective scalar values 401a, 402a, and 403a respectively. For example, a given vector may cause 50 milliseconds of CPU demand when executed while a second vector may cause 20 milliseconds of CPU demand when executed. If the ratio of these vectors for a customized benchmark comprises 50% of the first vector and 50% of the second vector, the benchmark represented by these vectors would cause 35 milliseconds of CPU demand when executed (50 milliseconds+20 milliseconds divided by 2). Thus, the ratio of benchmarks comprising second benchmark 440 can be applied to the performance metrics associated with the corresponding benchmarks comprising second benchmark 440 to determine the performance metrics 445 of second benchmark 440. In other words, as a result of creating second benchmark 440 using a ratio of pre-defined benchmarks, embodiments of the present invention can generate a set of performance metrics 445 which represent the resource demands placed upon enterprise application system 200 when second benchmark 440 is executed.

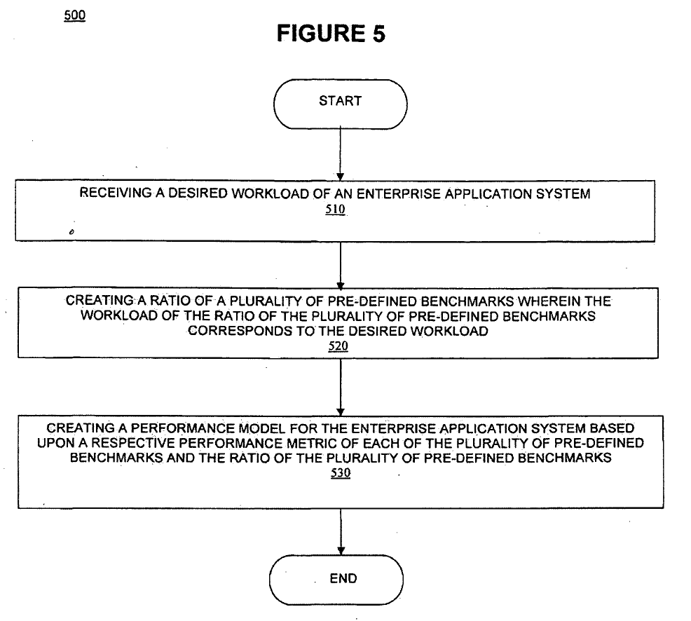

FIG. 5 is a flowchart of a computer-implemented method 500 for sizing an enterprise application system in accordance with an embodiment of the present invention. In operation 510 of FIG. 5, a desired workload of an enterprise application system is received. As described above, a client creates a customized business process model 205 which can be used to determine a desired workload imposed upon enterprise application system 200 when the client□s customized business process model 205 is implemented. As described above with reference to FIG. 4A, this desired workload can be represented as a vector 420 which describes the ratio of business objects invoked when the client□s customized business process model 205 is implemented.

In operation 520 of FIG. 5, a ratio of pre-defined benchmarks is created in which the workload of the ratio of pre-defined benchmarks correspond to the desired workload of the enterprise application system. As described above with reference to FIGS. 4A and 4B, embodiments of the present invention represent pre-defined benchmarks (e.g., 201, 202, and 203) as vectors (e.g., 401, 402, and 403 respectively) describing the ratio of business objects invoked when the respective benchmarks are executed. A ratio of the vectors is derived such that the workload imposed upon enterprise application system when the ratio of pre-defined vectors is executed corresponds to the ratio of business object invoked by the customized business process model 205 is implemented. This ratio is then applied to the respective benchmarks represented by the vectors in order to create a second benchmark 440 which corresponds to the workload imposed upon the enterprise application system when the client□s customized business process model 205 is implemented.

In operation 530 of FIG. 5, a performance model is created for the enterprise application system based upon a respective performance metric of each of the plurality of pre-defined benchmarks and the ratio of the plurality of pre-defined benchmarks. By applying the ratio of the pre-defined benchmarks to their corresponding performance metrics, embodiments of the present invention can create a performance model 445 which accurately represents the resource demands placed upon enterprise application system 200 when the client□s business process model 205 is implemented. For example, the communication load, server load, response times and other parameters can be accurately modeled by performance model 445 and used in determining resource allocation of enterprise application system 200. As a result, the allocation of resources of enterprise application system 200 can be performed more accurately than if pre-defined benchmarks are used in the conventional manner.

Additionally, once the client□s system has been deployed, second benchmark 440 can be used as a diagnostic tool to determine if sufficient resources have been allocated. For example, once resources have been allocated and configured to support customized business process model 205, workload generator 216, can access second benchmark 440 and perform stress testing of the deployed resources which support the customized business process model 205. This facilitates determining whether the resources allocated to supporting customized business process model 205 are sufficient, or if additional resources may be needed.

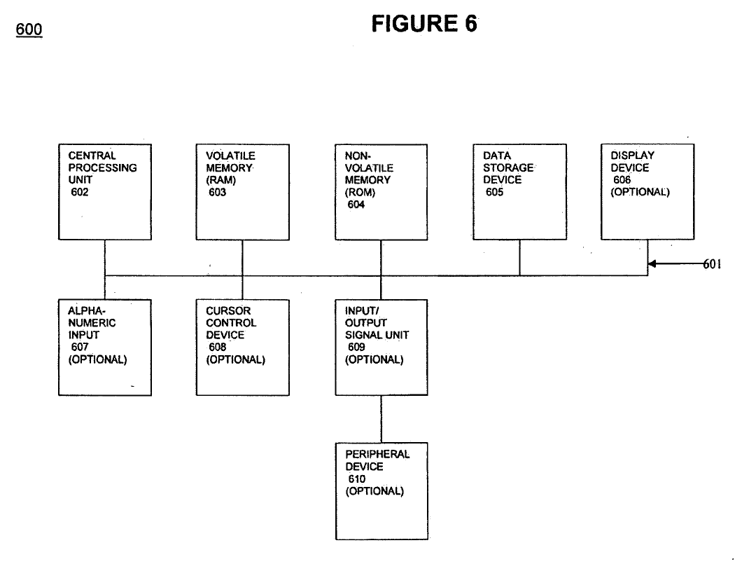

With reference to FIG. 6, portions of the present invention are comprised of computer-readable and computer-executable instructions that reside, for example, in computer system 600 which is used as a part of a general purpose computer network (not shown). It is appreciated that computer system 600 of FIG. 6 is exemplary only and that the present invention can operate within a number of different computer systems including general-purpose computer systems, embedded computer systems, laptop computer systems, hand-held computer systems, and stand-alone computer systems.

In the present embodiment, computer system 600 includes an address/data bus 601 for conveying digital information between the various components, a central processor unit (CPU) 602 for processing the digital information and instructions, a volatile main memory 603 comprised of volatile random access memory (RAM) for storing the digital information and instructions, and a non-volatile read only memory (ROM) 604 for storing information and instructions of a more permanent nature. In addition, computer system 600 may also include a data storage device 605 (e.g., a magnetic, optical, floppy, or tape drive or the like) for storing vast amounts of data. It should be noted that the software program for performing the sizing of an enterprise application system in accordance with the present invention can be stored either in volatile memory 603, data storage device 605, or in an external storage device (not shown).

Devices which are optionally coupled to computer system 600 include a display device 606 for displaying information to a computer user, an alpha-numeric input device 607 (e.g., a keyboard), and a cursor control device 608 (e.g., mouse, trackball, light pen, etc.) for inputting data, selections, updates, etc. Computer system 600 can also include a mechanism for emitting an audible signal (not shown).

Returning still to FIG. 6, optional display device 606 of FIG. 6 may be a liquid crystal device, cathode ray tube, or other display device suitable for creating graphic images and alpha-numeric characters recognizable to a user. Optional cursor control device 608 allows the computer user to dynamically signal the two dimensional movement of a visible'symbol (cursor) on a display screen of display device 606. Many implementations of cursor control device 608 are known in the art including a trackball, mouse, touch pad, joystick, or special keys on alpha-numeric input 607 capable of signaling movement of a given direction or manner displacement. Alternatively, it will be appreciated that a cursor can be directed and/or activated via input from alpha-numeric input 607 using special keys and key sequence commands. Alternatively, the cursor may be directed and/or activated via input from a number of specially adapted cursor directing devices.

Furthermore, computer system 600 can include an input/output (I/O) signal unit (e.g., interface) 609 for interfacing with a peripheral device 610 (e.g., a computer network, modem, mass storage device, etc.). Accordingly, computer system 600 may be coupled in a network, such as a client/server environment, whereby a number of clients (e.g., personal computers, workstations, portable computers, minicomputers, terminals, etc.) are used to run processes for performing desired tasks. In particular, computer system 600 can be coupled in a system for sizing an enterprise application system

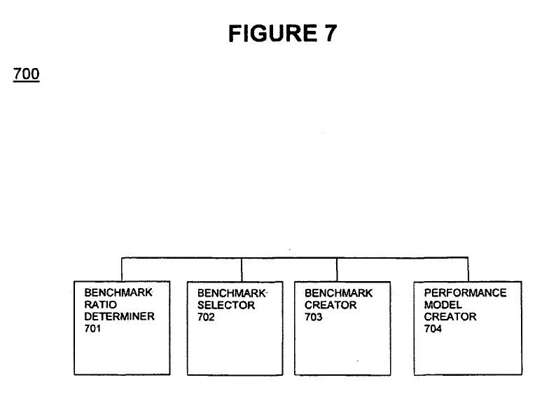

FIG. 7 is a block diagram of an enterprise application system sizing apparatus 700 in accordance with an embodiment of the present invention. In one embodiment, apparatus 700 comprises a benchmark ratio determiner 701 for determining a ratio of pre-defined benchmarks. As described above, embodiments of the present invention determine a ratio of benchmarks which generate a workload corresponding to a workload imposed upon an enterprise application system when a customized business process model is implemented. In one embodiment, benchmark ratio determiner 701 represents the customized business process model as a vector 420, and represents pre-defined benchmarks 201, 202, and 203 as corresponding vectors 401, 402, and 403 respectively. In one embodiment, benchmark ratio determiner 701 also assigns a scalar value to each of the vectors such that the sum of the products of the scalar values and their corresponding vectors is within a threshold value of the desired workload.

Apparatus 700 further comprises a benchmark selector 702 which selects the pre-defined benchmarks used by benchmark ratio determiner 701. As described above, embodiments of the present invention, the vectors are selected to utilize some or all of the M business objects represented by vector 420 such as those identified to affect the performance of enterprise application system 200 the most. Additionally, the benchmarks are selected so that the vectors comprising set A are selected to be linearly independent, or nearly linearly independent, from other vectors in set A.

Apparatus 700 further comprises a benchmark creator 703. Benchmark creator 703 is for creating second benchmark 440 which corresponds to the workload imposed upon enterprise application system 200 when customized business process model is implemented. In one embodiment, benchmark creator applies the ratio derived by benchmark ratio determiner 701 to a set of pre-defined benchmarks to create second benchmark 440.

Apparatus 700 further comprises a performance model creator 704 which creates performance model 445. In one embodiment, the ratio derived by benchmark ratio determiner 701 is applied to performance metrics 201a, 202a, and 203a to create performance model 445 which models the, resource demands placed upon enterprise application system 200 when second benchmark 440 and/or customized business process model 205 is executed.

The preferred embodiment of the present invention, a system and method for sizing enterprise application systems, is thus described. While the present invention has been described in particular embodiments, it should be appreciated that the present invention should not be construed as limited by such embodiments, but rather construed according to the following claims.

What is claimed is:

1. A computer-implemented method for sizing enterprise application systems, said method comprising:
determining a ratio of a plurality of pre-defined benchmarks wherein the workload of said ratio of said plurality of pre-defined benchmarks corresponds to a desired workload of an enterprise application system; and
using said ratio of said plurality of pre-defined benchmarks as a second benchmark for testing said enterprise application system.

2. The method as recited in claim 1 further comprising:
accessing a set of pre-defined benchmarks; and
selecting said plurality of pre-defined benchmarks based upon at least one business object comprising said enterprise application system.

3. The method as recited in claim 2 further comprising:
assigning a respective scalar value to each of said plurality of pre-defined benchmarks.

4. The method as recited in claim 3 further comprising:
generating a respective performance metric for each of said plurality of pre-defined benchmarks; and
using said ratio of said plurality of pre-defined benchmarks to create a performance model of said enterprise application system.

5. The method as recited in claim 4 further comprising:
deriving a product of said respective scalar value and said respective performance metric for each of said plurality of pre-defined benchmarks; and
summing said product of each of said plurality of pre-defined benchmarks.

6. The method as recited in claim 4 further comprising:
using said performance model to create a configuration of resources utilized by said enterprise application system.

7. The method as recited in claim 6 further comprising:
using said second benchmark to test said configuration of resources.

8. A computer-useable medium having computer-readable program code stored thereon for causing a computer system to execute a method for method for sizing enterprise application systems, said method comprising:
determining a ratio of a plurality of pre-defined benchmarks wherein the workload of said ratio of said plurality of pre-defined, benchmarks corresponds to a desired workload of an enterprise application system; and
using said ratio of said plurality of pre-defined benchmarks as a second benchmark for testing said enterprise application system.

9. The computer-useable medium as recited in claim 8 wherein said method further comprises:
accessing a set of pre-defined benchmarks; and
selecting said plurality of pre-defined benchmarks based upon at least one business object comprising said enterprise application system.

10. The computer-useable medium as recited in claim 9 wherein said method further comprises:
assigning a respective scalar value to each of said plurality of pre-defined benchmarks.

11. The computer-useable medium as recited in claim 10 wherein said method further comprises:
generating a respective performance metric for each of said plurality of pre-defined benchmarks; and
using said ratio of said plurality of pre-defined benchmarks to create a performance model of said enterprise application system.

12. The computer-useable medium as recited in claim 11 wherein said method further comprises:
deriving a product of said respective scalar value and said respective performance metric for each of said plurality of pre-defined benchmarks; and
summing said product of each of said plurality of pre-defined benchmarks.

13. The computer-useable medium as recited in claim 11 wherein said method further comprises:
using said performance model to create a configuration of resources utilized by said enterprise application system.

14. The computer-useable medium as recited in claim 13 wherein said method further comprises:
using said second benchmark to test said configuration of resources.

15. A method for sizing an enterprise application system, said method comprising: receiving a desired workload of an enterprise application system;
creating a ratio of pre-defined benchmarks wherein the workload of said ratio of pre-defined benchmarks corresponds to said desired workload; and
creating a performance model for said enterprise application system based upon a respective performance metric of each of said plurality of pre-defined benchmarks and said ratio of said plurality of pre-defined benchmarks.

16. The method as recited in claim 15 further comprising:
using said performance model to create a configuration of resources utilized by said enterprise application system.

17. The method as recited in claim 16 further comprising:
using said second benchmark to test said configuration of resources.

18. The method as recited in claim 15 further comprising:
accessing a set of pre-defined benchmarks; and
selecting said plurality of pre-defined benchmarks based upon at least one business object comprising said enterprise application system.

19. The method as recited in claim 18 wherein creating said ratio further comprises:
assigning a respective scalar value to each of said plurality of pre-defined benchmarks.

20. The method as recited in claim 19 wherein creating said ratio further comprises:
deriving a product of said respective scalar value and said respective performance metric for each of said plurality of pre-defined benchmarks; and
summing said product of each of said plurality of pre-defined benchmarks.
